(19) United States
(12) Patent Application Publication
(10) Pub. No.: US 2023/0303791 A1
(43) Pub. Date: Sep. 28, 2023

(54) Paintable and Painted Materials With Structured Surfaces

(71) Applicant: FRITZ EGGER GmbH & Co. OG, St. Johann in Tirol (AT)

(72) Inventor: Frank Kemmerling, Brilon (DE)

(21) Appl. No.: 18/015,005

(22) PCT Filed: Jul. 6, 2021
(86) PCT No.: PCT/EP2021/068618

§ 371 Date: Jan. 6, 2023

(30) Foreign Application Priority Data
Jul. 7, 2020 (EP) 20184608.6

(51) Int. Cl. C08J 7/18; C08L 79/06; C08J 3/28

(52) U.S. Cl. CPC C08J 7/18; C08J 3/28; C08L 79/06; C08J 2347/00

(57) ABSTRACT

The invention relates to a paintable material having a structured surface made of plastic containing amino groups, wherein at least a part of the amino groups on the structured surface has been functionalized covalently with vinyl groups by grafting a functionalizing reagent. Painted materials having structured paint surfaces can be obtained from these paintable material, wherein the invention also relates to said painted materials as well as to their production methods. The invention further relates to the use of a vinyl functionalization as a substitute for a primer layer or foundation in the painting of structured surfaces made of plastic containing amino groups with radiation-curing paints.

### CROSS-REFERENCE TO RELATED APPLICATIONS

This application is the U.S. National Phase of International Application No. PCT/EP2021/068618 filed Jul. 6, 2021, and claims priority to European Patent Application No. 20184608.6 filed Jul. 7, 2020, the disclosures of which are hereby incorporated by reference in their entirety.

### BACKGROUND OF THE INVENTION

### Field of the Invention

The invention relates to materials having structured surfaces made of plastics containing amino groups which are particularly suitable for subsequent painting, structured surfaces of plastics containing amino groups which have been painted, methods for their production, and the use of a vinyl functionalization in the painting of structured surfaces of plastics containing amino groups.

### Description of Related Art

When using materials in furniture manufacturing or for cladding floors, walls or ceilings, it is often desirable to design their surfaces in such a manner that they not only have the look but also the feel of natural models such as wood, ceramics or stone. For this purpose, it is known in the prior art to produce correspondingly structured decors on material boards.

For example, the production of flooring laminate is usually done as follows: First, an impregnated decorative paper (so-called impregnate) is created by printing the desired decore (wood grain, ceramic, mosaic, tile etc.) onto a paper web, which is then impregnated with aminoplast resin. The resulting impregnate can be rolled up on a roll or laid down in sheets and stored. In a second step, a carrier board (e.g., MDF, HDF, particleboard or similar) is coated with the impregnate. For this purpose, the impregnate and, if necessary, other aminoplast resin-impregnated underlay and overlay papers are placed on the carrier board and then pressed together with the wooden material board in a press under the influence of temperature. Under the influence of pressure and temperature, the resin melts, forming a homogeneous film layer and at the same time bonding the paper to the wooden material carrier. The upper press board of the press can be provided with a relief as a die, which advantageously matches the decoration. During pressing, the corresponding impressions of the press sheet are then used to form depressions in the aminoplast resin surface which, for example, resemble the surface of a wooden board, the roughness of a natural stone floor or the joints of laid tiles or mosaic stones, in order to form a surface on the wooden material board which is as true to nature as possible. The surface of the aminoplast resin layer reproduces the negative structure of the press sheets used.

In a similar manner, other material surfaces made of plastics containing amino groups can also be formed in a structured manner during production. For example, aminoplast resins can also be applied in powder form and compressed with carriers, or a separate coating of a carrier with an aminoplast resin or another plastic containing amino groups can be applied. Materials that already consist of plastics containing amino groups or contain them as binders (such as a large proportion of particleboard and fiberboard) can also be given a structured surface. In addition to embossing using structured press sheets, decorative structures can also be created using lamination, calendering, etching, lasering or three-dimensional printing.

However, a disadvantage of the prior art has so far been the poor paintability of surfaces made of plastics containing amino groups and provided with decorative structures. The common radiation-curing paints adhere poorly to plastic surfaces containing amino groups. For this reason, primer layers or undercoats must be applied as adhesion promoter layers before the actual painting of the plastic surface with radiation-curing paints can take place. For the melamine resin surfaces that are particularly difficult to paint, for example, special primer layers or even hot-melt adhesives have been developed that can be applied directly to aminoplast resin surfaces and then serve as a base for one or more further paint layers.

However, due to this compulsory multi-layer and thus thick paint build-up, an underlying structure of the surface is lost during painting (see FIG. 5b).

However, it would be desirable to be able to paint structured surfaces while retaining the structure. In this manner, the optical and decorative effects of structured surfaces described at the beginning could be combined with those of a painting. Particularly with plastic surfaces containing amino groups, and especially with aminoplast resin surfaces, overpainting would often be necessary to set the desired surface properties.

It is true that plastics containing amino groups in general and aminoplast resins in particular have good hardness, chemical resistance, and heat and fire resistance. However, there are also disadvantages in the surface properties.

A disadvantage of aminoplast resin surfaces in particular is the high gloss level, which is perceived as annoying, especially when the aim is to imitate natural surfaces, as these usually have a much duller appearance. Many consumers perceive a matte surface as resting point for the eye in contrast to an intrusive high-gloss surface. It is further advantageous that matte surfaces compensate for unevenness of the substrate to a greater extent than glossy surfaces. The high gloss level also means that aminoplast resin surfaces are visually very susceptible to contamination of an organic nature, such as by food residues, grease and, above all, fingerprints. Such contamination is very easily noticed on high-gloss plastic surfaces and affects the decorative effect or makes the surface look dirty and unhygienic.

To adjust the gloss level and, in particular, to prevent soiling by fingerprints, aminoplast resin surfaces are partially overpainted. For this purpose, specially developed so-called anti-fingerprint coatings are also available. But even apart from the anti-fingerprint effect, painting the aminoplast resin surface with a matte paint is often a good idea for the reasons mentioned above. The wood and furniture industry is one of the largest consumers of dull matte, matte or silk matte UV paints, which have been specially developed for this industry. Synthetic silicas, for example, are used as matting agents. In addition, however, with UV paints it is also possible to achieve matte effects physically, i.e., without adding matting agents. For example, so-called excimer UV curing can be used to produce particularly microstructured and thus matte surfaces (see, e.g., Jorge and Kiene. Holzbeschichtung. FARBE UND LACK, 2019, p. 132-133).

Plastic surfaces containing amino groups, and especially melamine surfaces, are sometimes perceived by consumers as artificial also because they “feel cold”. This can also be improved by structuring the surface or overpainting.

A painting can also be used to advantageously adjust the mechanical and chemical surface properties. In particular, it is known that plastic surfaces containing amino groups have comparatively poor UV, weathering and micro-scratch resistance. Also for this reason aminoplast resin surfaces are often overpainted in practice with more resistant UV paint structures. In the field of parquet coatings, for example, UV topcoats with very high paint hardness and scratch resistance are known. In the case of aminoplast resin surfaces, it is particularly important to increase micro-scratch resistance.

Unfortunately, it has not yet been possible in the prior art to combine the optical and decorative advantages of structured material surfaces made of plastics containing amino groups with those of painting with radiation-curing paints in a simple and cost-effective manner.

### SUMMARY OF THE INVENTION

The object of the present invention was therefore to achieve structured paint surfaces on material substrates made of plastics containing amino groups in a simple and cost-effective manner.

This object is solved according to the invention by the paintable material as described herein, the painted material as described herein, the methods for their production as described herein, and the use as described herein. Particular embodiments of the invention are set forth in the dependent claims and are explained in more detail below, as is the general idea of the invention.

The invention provides a material having a structured surface of a plastic containing amino groups, wherein at least a part of the amino groups on the structured surface of the plastic containing amino groups has been functionalized covalently with vinyl groups by grafting a functionalizing reagent. This surface functionalization eliminates the need for a primer layer or undercoat. The structured surface according to the invention is directly paintable. For this reason, this first subject matter of the invention is also referred to herein as “paintable material”.

The paintable material according to the invention can be produced by the method also provided by the invention, which comprises the following steps:
a) providing a material having a structured surface made of a plastic containing amino groups,
b) covalent functionalization of the structured surface with vinyl groups by
   (i) contacting the structured surface with a functionalizing reagent having at least one vinyl group and at least one further group reactive toward the amino groups of the plastic containing amino groups, and
   (ii) performing a chemical reaction to generate a covalent bond between the second reactive group of the functionalizing reagent and an amino group on the structured surface of the plastic containing amino groups, thereby obtaining a structured surface covalently modified with vinyl groups.

The advantage of the paintable material provided by the invention is that it can be painted with a correspondingly thinner layer of paint by dispensing with a primer layer or undercoat, thus retaining the structure originally already present in the substrate after painting. For the first time, structured paint surfaces can be produced on plastics containing amino groups in a particularly simple and cost-effective manner.

Accordingly, the invention also provides a painted material having a structured paint surface, which can be obtained by painting the paintable material according to the invention. The method for producing the painted material according to the invention comprises the steps:
(a) providing a paintable material according to the invention,
(b) applying a layer of a radiation-curing paint to the vinyl group-modified, structured plastic surface of the paintable material, and
(c) radiation curing of the paint layer.

The invention therefore also comprises, in particular, the use of a vinyl functionalization as a substitute for a primer layer or undercoat in the painting of structured surfaces of plastics containing amino groups. This allows a significant reduction in paint layer thickness, making it possible for the first time to paint even structured substrates while retaining the surface structure.

### DETAILED DESCRIPTION OF THE INVENTION

### Plastic Containing Amino Groups

When the term “plastic containing amino groups” is used herein, it refers to any plastic that has primary and/or secondary amino groups in its molecular structure. Plastic is to be understood as a polymer material according to its usual meaning. Unless further specified herein, “plastic” or “resin” always means a solid, cured condensation product. According to a preferred embodiment, the plastic containing amino groups has primary amino groups. These may be located, in particular, at the ends of the polymer molecule. According to another preferred embodiment, the plastic containing amino groups has secondary amino groups. Surprisingly, the functionalization according to the invention also works very well with these. In one embodiment, the functionalization occurs via the secondary amino groups of the plastic containing amino groups. Plastics containing amino groups are known to the person skilled in the art. These can be selected, for example, from the group consisting of aminoplast resins, aminopolysiloxanes, polyvinylamines, polyalkyleneimines, amine-modified epoxy resins and polyurethanes with terminal amino groups.

According to a particularly preferred embodiment, the plastic containing amino groups is an aminoplast resin, in particular a melamine-formaldehyde resin. Aminoplast resins are very versatile plastics that are used in a wide variety of compositions and forms. In order to increase the surface durability of layered materials, laminates and/or wooden materials, it is known to coat their surface with a layer of aminoplast resin (in practice typically a melamine-formaldehyde resin), for example in the form of a so-called fluid overlay or impregnated overlay paper. In practice, aminoplast resins are also usually used as impregnating resins or binders for the underlying layers. In addition to impregnating, soaking and/or coating surfaces, aminoplast resins are also generally known to the person skilled in the art working in the wood processing industry, above all as glues, e.g., for particleboard or fiberboard production. Surfaces made of plastics containing amino groups also occur here. However, aminoplast resins can also be applied in powder form to carrier materials and pressed with them. All these applications of aminoplast resins known to the person skilled in the art result in materials having surfaces made of a plastic containing amino groups within the meaning of the invention.

Aminoplast resins or aminoplastics are described in “Ullmanns Enzyklopädie der technischen Chemie”, 4^{th} edition, 1974, in the chapter “Aminoplaste” in volume 7 or in “Holzwerkstoffe und Leime” by Dunky and Niemz, 1^{st} edition, 2002, in volume I, part II, chapter 1. The term aminoplast generally refers to condensation products obtained by reaction of a carbonyl compound, in practice usually formaldehyde, with a component containing amino, imino or amide groups.

According to the invention, the most important representatives of the aminoplast resins are melamine-formaldehyde resins. These include all aminoplast resins formed from at least melamine and formaldehyde, for example, also melamine urea formaldehyde resins. The latter are aminoplast resins formed from at least melamine, urea and formaldehyde. Melamine-formaldehyde resins can also contain other components in addition to melamine and formaldehyde, in particular other components containing carbonyl and amino, imino or amide groups, as well as additives and/or solvents. Melamine-formaldehyde resins, also known simply as melamine resin or melamine surfaces by a person skilled in the art, have become widely used as surfaces, particularly in furniture manufacturing and interior finishing materials. Here in particular, there is a great demand for both structured and painted surfaces as explained at the beginning. The problem of the undesirable gloss level and the associated artificial look and feel is particularly acute with melamine-containing aminoplast resin surfaces.

Polyvinylamines are prepared via polymer analogous reactions such as by hydrolysis of poly-N-vinylamides, such as poly-N-vinylformamide or poly-N-vinylacetamide, or poly-N-vinylimides, such as poly-N-vinylsuccinimide, readily available by polymerization of the corresponding monomers, or by Hofmann degradation from polyacrylamide.

Polyalkyleneimines are polymers with a backbone containing N atoms linked by alkylene groups, which can carry alkyl groups on the non-N atoms. The polyalkyleneimine preferably has primary amino functions at the ends and preferably has both secondary and tertiary amino functions in the interior; optionally, it may have only secondary amino functions in the interior, resulting in a linear polymer rather than a branched chain polymer. The ratio of primary to secondary amino groups in the polyalkyleneimine is preferably in the range of 1:0.5 to 1:1.5, in particular in the range of 1:0.7 to 1:1. The ratio of primary to tertiary amino groups in the polyalkyleneimine is preferably in the range of 1:0.2 to 1:1, in particular in the range of 1:0.5 to 1:0.8.

Aminoepoxide resins are obtained by reacting epoxy resins with polyamines as curing agents, wherein the reaction conditions are selected in such a manner that terminal amino groups remain in the resin after the reaction. Epoxy resins are synthetic resins that carry epoxy groups. They are curable resins (reactive resins) that can be reacted with a curing agent and, if necessary, other additives to form a thermoset plastic. Epoxy resins are polyethers with usually two terminal epoxy groups. The curing agents are reaction partners and, together with the resin, form the macromolecular plastic. Aminoepoxy resins as used herein represent such a macromolecular plastic obtained by reacting epoxy resins with polyamines as curing agents. The reaction conditions are selected in such a manner that terminal amino groups remain in the resin after the reaction.

Polyurethanes having terminal amino groups can be obtained by reacting polyurethane having residual NCO groups in the polyurethane with diamines.

### Material

The term “material” as used herein comprises any molded body that can be subjected to painting. For example, it may be a furniture component or a component suitable for covering floors, walls or ceilings. As explained at the beginning, it is often desirable to provide their surfaces with a structuring in such a manner that they not only have the look but also the feel of natural models such as wood, ceramics or stone. For this purpose, it is known in the state of the art to produce correspondingly structured decors on materials for furniture or components.

In a preferred embodiment, the paintable or painted material according to the invention is a wooden material board; a carrier coated with a plastic containing amino groups; an impregnated or coated paper or a laminate containing one or more impregnated or coated papers, in particular a DPL, HPL or CPL, a compact board or another layered material.

The paintable or painted material according to the invention is preferably a sheet-shaped or board-shaped material. However, other geometries are also possible, and in particular the material can also be a more complex three-dimensional molded part. According to a preferred embodiment, the material, particularly if it is sheet-shaped or board-shaped, is suitable for producing furniture surfaces or for cladding floors, walls or ceilings.

Sheet-shaped or board-shaped materials have the advantage of having a largely flat surface. This can be provided with structuring in a relatively simple manner and with high throughput, for example by using structured press sheets during production or by subsequent laminating, calendering with a structuring roller, etching, lasering or three-dimensional printing. The functionalizing reagent according to the invention and the subsequent painting can also be applied to sheet-shaped or board-shaped materials particularly evenly and over a wide area, for example by rolling, spraying, gunning, flooding, dipping, casting, doctoring and/or brushing on.

The sheet-shaped material can be rolled onto a roll or stored in sheets. In particular, the sheet-shaped material can be an impregnate or a layered material.

In a preferred embodiment, the material according to the invention is a paper impregnated and/or coated with a plastic containing amino groups (in particular an aminoplast resin). The person skilled in the art also refers to this as “impregnate”. According to another preferred embodiment, the material according to the invention is a laminate containing a plurality of papers impregnated and/or coated with a plastic containing amino groups (in particular an aminoplast resin) or a laminate containing one or more such papers and a carrier material. Laminates of several impregnated and/or coated papers and, if necessary, carriers are referred to as layered materials. Both impregnates and laminates or respectively layered materials are widely used in the production of furniture surfaces or for covering floors, walls or ceilings, especially for the production of floor panels.

Laminate, as used herein, means an article comprising at least two layers bonded together in a planar manner. These layers can be made of the same or different materials. Laminates according to the invention have a layered structure, wherein the uppermost layer has a decorative paper impregnated with an aminoplast resin, overlay paper or a specially applied layer of aminoplast resin, for example in the form of a so-called liquid overlay. The aminoplast resin is preferably a melamine-formaldehyde resin. Overlay paper and liquid overlay layers are used to protect the surface from external influences such as abrasion and scratching.

The laminate is preferably obtained by pressing together one or more layers of paper impregnated and/or coated with a plastic containing amino groups (in particular an aminoplast resin) under pressure and heat with optionally further papers impregnated with synthetic resin and optionally a carrier board. In this context, the structured surface of a plastic containing amino groups provided according to the invention is preferably achieved by introducing the structure into the surface of a plastic containing amino groups during the production of the laminate by embossing with a structured press sheet or calendering with a structured roller. The surface of plastic containing amino groups is preferably formed by a paper arranged on the surface of the laminate and impregnated and/or coated with a plastic containing amino groups (in particular aminoplast resin) or a layer of a liquid overlay of plastic containing amino groups (in particular aminoplast resin).

If the material is a laminate, it may in particular be a “Direct Pressure Laminate” (DPL), “High Pressure Laminate” (HPL) or “Continuous Pressure Laminate” (CPL). DPL are manufactured by pressing together one or more layers of resin impregnated papers with a carrier board under pressure and heat. HPL are manufactured by pressing together several layers of resin-impregnated papers under pressure and heat in a single or multi-daylight press. This is thus a particular embodiment of a layered material. The HPL can then be glued onto a carrier board, laminated onto it or pressed with it under pressure and heat. CPL are manufactured by pressing together several layers of resin-impregnated papers under pressure and heat in a continuous press, usually a double belt press. Thus, CPL is also a particular embodiment of a layered material. A special type of CPL is the continuous pressing of one or more layers of resin-impregnated paper with a carrier board. All the above technologies are used for the production of furniture surfaces or for the production of components for covering floors, walls or ceilings, particularly in the production of laminate flooring. Phenolic resins are often used as synthetic resins for impregnating the inner paper layers. At least on the surface of the laminates or layered materials, however, there are one or more papers impregnated with a plastic containing amino groups, in particular a melamine-formaldehyde resin, in particular decorative paper and overlay paper. The latter is a transparent paper impregnated with melamine-formaldehyde resin, which serves as a protective layer and may contain additional anti-abrasive components. A decorative paper is a printed or dyed special paper used in aminoplast resin impregnated form for decorative coating of wooden materials.

The material according to the invention may be a compact board. This refers to a laminate pressboard that is produced in a similar manner to HPL by pressing several layers of resin-impregnated paper together under pressure and heat. While HPL laminates primarily serve as coating material and are applied to carrier materials, compact boards can be designed on both sides and are used without a carrier material. Compact boards are abbreviated according to DIN as DKS for “Dekorativer Kunststoff-Schichtpressstoff” (in English: decorative plastic layered press material). They usually consist of several layers of paper or fabric, the core of which is soaked in phenolic resin and the edge layers in melamine-formaldehyde resin, and then joined together under heat and pressure.

The wooden material board can be a particleboard, OSB board or fiberboard. What these have in common is that particles containing lignocellulose (chips, strands or fibers) are glued with binder during their production and then pressed into the wooden material. OSB (oriented strand board, or oriented structural board, respectively) is a rough particleboard made from long, slender chips (“strands”). Particleboard, OSB board or fiberboard are largely aminoplastically bonded wooden material boards.

In order to have a surface of a plastic containing amino groups, the wooden material board has either been produced with a plastic containing amino groups as a binder or has been subsequently coated with a plastic containing amino groups or an impregnate or laminate or respectively layered material containing a surface of a plastic containing amino groups. The plastic containing amino groups is preferably an aminoplast resin, in particular a melamine-formaldehyde or melamine-urea-formaldehyde resin. According to a preferred embodiment, the material is a wooden material board coated with an aminoplast resin-impregnated paper which, after embossing during pressing to form the material board, depicts the structured aminoplast resin surface of the wooden material board. This corresponds to the DPL embodiment described above.

The material according to the invention can also be, in general, a carrier coated with a plastic containing amino groups.

Where reference is made herein or elsewhere to “carrier”, “carrier material” or “carrier board”, this may in particular be a wooden material, mineral material, metal or plastic board. This is especially true for the DPL, HPL and CPL embodiments described above. The terms “wooden”, “mineral”, “metal” and “plastic” refer to the main components of the carrier board in terms of quantity (wt.%). The carrier board itself can also be a laminate or layered material.

Whenever “coating” or “coat” with the plastic containing amino groups is referred to herein or elsewhere, it is understood to mean any form of coating. The plastic containing amino groups can be applied in fluid form, for example in the form of its monomers or precondensates, and then cured. However, the plastic containing amino groups can also be applied in powder form as a layer and then bonded, melted or cured. “Coating” or “coat” is understood here quite generally to mean both the application of a layer of plastic containing amino groups and the pressing or laminating with one or more papers impregnated and/or coated with a plastic containing amino groups (in particular an aminoplast resin).

### Functionalization With Vinyl Groups

A core aspect of the invention is to make the structured surface of the material, which consists of a plastic containing amino groups, directly paintable by functionalization with vinyl groups. This eliminates the need for additional primer or undercoat layers. For structured substrates, this has the advantage that the surface structuring is retained even after painting.

To make this possible, according to the invention at least part of the amino groups on the structured surface of the plastic containing amino groups is functionalized covalently with vinyl groups by grafting a functionalizing reagent. Grafting is accomplished by bringing the structured material surface, which contains a plastic containing amino groups, into contact with the functionalizing reagent and inducing a reaction. The plastic containing amino groups is thus covalently functionalized with vinyl groups in the cured state only on its surface.

The paintable material obtained according to the invention has vinyl groups on its surface, which are covalently anchored in the plastic containing amino groups located on its surface. This provides particularly good adhesion for radiation-curing paints, which also cure radically via vinyl groups. In the painted material according to the invention (see below), the paint layer is thus covalently anchored in the plastic containing amino groups, which is located on the surface of the material. This results in particularly good adhesion of the paint layer and makes it possible to dispense with a primer or undercoat layer.

In the context of the present invention, the term “vinyl group” comprises any functional group having a terminal C═C double bond. Such a double bond is suitable for participating in the radiation-curing-initiated radical polymerization of a radiation-curing paint.

Functionalizing reagent, as used herein, means a molecule that can be grafted onto an amino group located on the structured surface of the plastic containing amino groups. By the functionalizing reagent also having at least one vinyl group in addition to this grafting functionality, the structured surface of the plastic containing amino groups is functionalized by the grafting of the functionalizing reagent with vinyl groups. The functionalizing reagent is thus an at least bifunctional molecule (see FIGS. 3a and 3c). As the first functional group A, it has a vinyl group. As a second functional or reactive group B, the functionalizing reagent has a group reactive toward the amino groups of the plastic containing amino groups. Thus, the functionalizing reagent has at least one vinyl group and at least one other group reactive toward the amino groups of the plastic containing amino groups. The grafting of the functionalizing reagent consists of the further functional group B having reacted with an amino group on the surface of the plastic containing amino groups to form a covalent bond. As a result, vinyl groups are grafted onto amino groups located on the structured surface of the material. When amino groups are mentioned herein, this refers in particular to terminal —NH₂ groups present in the plastic containing amino groups.

For grafting, the structured material surface, which has a plastic containing amino groups, is brought into contact with the functionalizing reagent and a reaction is induced.

The first step in the covalent functionalization of the structured surface with vinyl groups thus consists in bringing the structured surface into contact with a functionalizing reagent having at least one vinyl group and at least one further group reactive toward the amino groups of the plastic containing amino groups. Contacting is achieved by applying the functionalizing reagent to the structured material surface, which has a plastic containing amino groups. The application can be done in a variety of ways. According to the invention, it has been shown that even selective functionalization of the surface with vinyl groups is sufficient to result in a considerable improvement in adhesion as reactive binding anchors for the layer of radiation-curing paint to be applied later. Preferably, however, the functionalizing reagent is applied to the entire structured surface of the plastic containing amino groups. The functionalizing reagent can be applied, for example, by rolling, spraying, gunning, impregnating, casting, doctoring, and/or brushing on.

The second step in the covalent functionalization of the structured surface with vinyl groups consists in reacting the functionalizing reagent with at least a part of the primary and/or secondary amino groups present on the surface of the structured material. This step involves performing a chemical reaction to generate a covalent bond between the second reactive group of the functionalizing reagent and an amino group on the structured surface of the plastic containing amino groups, thereby obtaining a structured surface covalently modified with vinyl groups.

In this case, the reacting occurs under reaction conditions that allow covalent bonding between the further reactive group B of the functionalizing reagent and the terminal amino groups of the aminoplast resin. The reaction conditions depend on the chemistry of the further reactive group B. In many cases, heating of the material surface will be necessary. This can be achieved via radiant heaters or ovens. Preferably, after application of the functionalizing reagent, the material surface is heated to a surface temperature of 30° C. to 100° C., preferably 50° C. to 80° C., and particularly preferably 60° C. to 70° C.

In other cases (such as, for example, the aza-Michael addition discussed in more detail below), irradiation of the surface with high-energy radiation is sufficient according to the invention. The radiation dose is preferably at least 100 mJ/cm², preferably at least 150 mJ/cm². For reflective surfaces, the latter doses are required (e.g., for white surfaces). Good results have been obtained when the radiation dose was in the range of 100 to 1000, preferably 150 to 600 mJ/cm². In practice, the high-energy radiation is usually UV or electron beams. According to the invention, UV radiation summarizes the wavelength ranges of UVB radiation (280–320 nm), UVA2 radiation (320–340 nm) and UVA1 radiation (340–400 nm). UVC radiation (200 –280 nm), vacuum UV radiation (100-200 nm), special excimer radiation (172 nm) and extreme UV radiation (1–100 nm) are also grouped under the term UV radiation. Preferably, the high-energy radiation is one with a wavelength of 280 nm or less. UV-C radiation is particularly practical.

Depending on the nature of the grafting reaction, it may also be necessary to apply the functionalizing reagent together with required catalysts, additives or solvents in a composition or separately from another. The person skilled in the art can easily verify whether the grafting reaction was successful by examining the adhesion of a paint layer to the material surface treated with the functionalizing reagent. Only if covalent functionalization with vinyl groups – and thus grafting of the functionalizing reagent – has occurred, very good adhesion is achieved even without the otherwise required paint primer or undercoat layer.

Depending on the degree of conversion and the amount of functionalizing reagent applied, it may be advisable to at least partially remove excess non-covalently attached functionalizing reagent from the surface after the reaction before providing it with a paint layer. Removal can be done simply by washing with a suitable solvent or wiping the surface. However, practical testing of the invention has shown that in many cases this is not necessary because, on the one hand, if the correct application amounts and reaction conditions are selected, an almost complete reaction occurs and, on the other hand, due to the obligatory presence of a vinyl group, the functionalizing reagents also are incorporated by polymerization into the paint layer during the free-radical polymerization of a radiation-curing paint and therefore do not interfere with the paint film formation.

Because of the wide variety of grafting chemistries available for amino group functionalizations, the number of options for reactive group B and associated reaction pathways is also correspondingly large. The further group B of the functionalizing reagent which is reactive toward the amino groups of the plastic containing amino groups may in particular be selected from the group consisting of epoxides, acid anhydrides, acid chlorides, acid azides, sulfonyl chlorides, ketones, aldehydes, carboxylic acids, esters, in particular N-hydroxysuccinimide esters, imido esters, or carbonates, carbodiimides, isocyanates, isothiocyanates, alkyl halides, aryl halides, alkynes and vinyl groups such as, e.g., acrylate, methacrylate or acrylamide. All of these functional groups are capable of reacting with amino groups under conditions well known to the person skilled in the art. Most of these groups react with primary or secondary amines by acylation to the acid amide or by alkylation to the secondary (or tertiary) amine. The reaction mechanisms and conditions are known to the person skilled in the art and can be looked up in the relevant textbooks on organic chemistry or the relevant journals.

According to a particularly preferred embodiment, the group in the functionalizing reagent that is reactive toward the amino groups of the plastic containing amino groups is a vinyl group. In this particularly preferred embodiment, the functionalizing reagent thus comprises at least two vinyl groups. The first is used for anchoring in the plastic containing amino groups, while the second is retained after grafting and is used for subsequent anchoring of the radiation-curing paint to be applied. The first and second vinyl groups may be identical or different from one another, preferably they are identical. Particularly preferably, the functionalizing reagent is a mirror-symmetric molecule having at least two vinyl groups.

The research underlying this invention has shown that vinyl groups are quite suitable for grafting functionalizing reagents onto structured plastic surfaces containing amino groups. Under the influence of high-energy radiation, the vinyl groups react with the amino groups on the solid material surface in an aza-Michael addition. The aza-Michael addition of a primary amino group on the material surface with an acrylate group in the functionalizing reagent is shown schematically below:

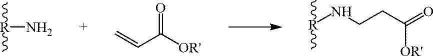

The corresponding reaction also occurs, or – as the inventors have found –primarily occurs also with secondary amines in the plastic containing amino groups. This was recognized in a series of tests where no difference was seen in the functionalization depending on the number or the presence of primary amino groups in the plastic containing amino groups. Secondary amino groups appear to be sufficient according to the invention.

Practical tests have shown that in the case of functionalizing reagents having two vinyl groups, only one of the two reacts with amino groups in the material surface. The other thus remains present as a functionalization in the material surface, as desired. This is probably due to several reasons. First, it is a solid-phase or solid/liquid reaction, which means that there is no mixing of the reactants. It therefore seems sterically unlikely that the second vinyl group in the functionalizing reagent, which protrudes from the material surface after grafting, will “find” another amino group in the surface to complete another aza-Michael addition. However, the size of the molecule and spacer length of the functionalizing reagent also appear to play a role, as discussed in more detail below. At least in the case of plastics containing amino groups, which have only terminal amino groups, the density of amino groups on the material surface will also not be sufficient for both vinyl groups of a functionalizing reagent to react with it.

The aza-Michael reaction between a vinyl group of the functionalizing reagent and an amino group in the material surface has the advantage that the functionalizing reagent only needs to be applied to the material surface and subsequently subjected to irradiation with high-energy radiation (such as UV light or electron beam). In the material surface, both primary and secondary amines can attach to the C═C double bond of the vinyl group of the functionalizing reagent in an aza-Michael addition.

For the aza-Michael addition, it is important that the high-energy radiation actually penetrates to the complexes of vinyl and amino groups that are initially formed. Only in this manner the electron-donor-acceptor or charge-transfer complexes necessary for Michael addition are formed and resolved by addition to the alkylamine. Since the amino group is located directly in the material surface, the complexes also form only directly on the material surface. The layer of the applied functionalizing reagent must not be too thick, otherwise the high-energy radiation will not penetrate to the material surface. Particularly good results were obtained when the functionalizing reagent was applied in an amount not exceeding 3 g/m², preferably not exceeding 2 g/m², and especially preferably not exceeding 0.5 g/m² or 1 g/m².

If the functionalizing reagent is not applied in pure form but in the form of a composition, this must not contain any materials that absorb the high-energy radiation. In particular, no photoinitiators or radical initiators, as is otherwise customary in paints, may be contained, since these would not only intercept the high-energy radiation, but would in particular also result in a radical polymerization of the vinyl group-containing functionalizing reagent, which is not desired. Such polymerization and film formation would mean that the vinyl groups intended for functionalization would no longer be available and would also prevent the high-energy radiation from penetrating to the material surface to trigger the desired aza-Michael reaction between the functionalizing reagent and the material surface.

For the same reason, functionalization of, for example, melamine resin surfaces with vinyl groups have not yet occurred in the prior art when these surfaces have been coated with radiation-curing paints. On the one hand, the radiation is intercepted by the primer, undercoat or paint layers themselves, which are applied relatively thickly in the prior art, and in particular by radiation-absorbing molecules such as photoinitiators contained therein, and does not reach the material surface. Thus, radiation-induced aza-Michael additions do not occur at the material surface in the prior art. However, even if this were the case, during radiation curing all vinyl groups contained in the primer, undercoat or paint composition react completely within a few seconds in the radiation-induced radical polymerization. Thus, there is no functionalization of the material surface with vinyl groups.

In a preferred embodiment of the invention, the functionalizing reagent is applied to the structured surface of the plastic containing amino groups in an amount of less than 5 g/m², in particular less than 2 g/m² or less than 1 g/m². This is particularly advantageous if the functionalizing reagent and the amino groups are reacted by means of high-energy radiation or respectively if the further group contained in the functionalizing reagent that is reactive toward the amino groups of the plastic containing amino groups is a vinyl group. This is because it is essential for radiation-induced aza-Michael addition at the material surface that the high-energy radiation also reaches the surface.

However, even when functionalization is not based on radiation-induced aza-Michael addition, these application amounts have been shown to be beneficial and sufficient. As explained at the outset, the inventors have recognized that a layer thickness as thin as possible on the structured material surface is necessary in order to preserve its structuring during subsequent painting. With this in mind, the “layer” of functionalizing reagent should also be as thin as possible. In this context, it is also not appropriate to speak of a layer at all, since the functionalizing reagent reacts with the material surface and is subsequently no longer recognizable as a separate layer.

After application of the functionalizing reagent to the structured surface of the plastic containing amino groups, it is preferably irradiated with high-energy radiation as described further above. In particular, for functionalization using aza-Michael additions, this establishes the preferred reaction conditions to ensure covalent attachment to the solid material surface. The type and intensity of the high-energy radiation should be selected in such a manner that the complexes formed on the material surface between functionalizing reagent and amino groups are excited and react in aza-Michael reactions.

The vinyl groups in the functionalizing reagent or in the functionalized material surface can in particular be selected from the group consisting of acrylates, methacrylates, vinyl ethers, allyl ethers and vinyl aromatic compounds. The latter include, for example, styrene, C₁₋₄ alkyl-substituted styrene, stilbene, vinylbenzyldimethylamine, (4-vinylbenzyl)dimethylaminoethyl ether, N,N-dimethylaminoethylstyrene, tert-butoxystyrene and vinylpyridine. Particularly preferably, the group in the functionalizing reagent that is reactive towards the amino groups of the plastic containing amino groups is an α,β-unsaturated carbonyl compound, in particular α,β-unsaturated carboxylic acid esters, or α,β-unsaturated carboxylic acid amides. Acrylic acid and/or methacrylic acid esters are particularly preferred. α,β-unsaturated carbonyl compounds or compounds that are α,β-unsaturated with respect to another electron-withdrawing group are particularly suitable for aza-Michael additions. Preferably, the vinyl group is a vinyl group that is directly linked to an electron-withdrawing group, such as a carbonyl group.

Particularly good results are obtained when the functionalizing reagent is selected from the group consisting of di-, tri-, tetra-, penta- or even higher functional acrylates, methacrylates, vinyl ethers and allyl ethers. The functionalizing reagent can be selected in particular from the group consisting of trimethylolpropane triacrylate, dipropylene glycol diacrylate, tripropylene glycol diacrylate, hexanediol diacrylate, pentaerythritol tetraacrylate, dipentaerythritol pentaacrylate, dipentaerythritol hexaacrylate, neopentyl glycol diacrylate, and propoxylated or ethoxylated variants of these compounds, polyalkylene glycol diacrylates, in particular polyethylene glycol diacrylates, divinyl ethers, in particular diethylene glycol divinyl ethers, triethylene glycol divinyl ethers or cyclohexanedimethanol divinyl ethers, and diallyl ethers. The molecular weights of some of these compounds are given below:

TABLE 1

| | |
|---|---|
| Substance | relative molar mass (Mᵣ) |
| Diallyl ether | 98.14 |
| Diethylene glycol divinyl ether | 158.20 |
| Cyclohexane dimethanol divinyl ether | 196.29 |
| Triethylene glycol divinyl ether | 202.25 |
| Neopentyl glycol diacrylate | 212.24 |
| Hexanediol diacrylate | 226.27 |
| Dipropylene glycol diacrylate | 242.27 |
| Trimethylolpropane triacrylate | 296.32 |
| Tripropylene glycol diacrylate | 300.35 |
| Pentaerythritol tetraacrylate | 352.34 |
| Dipentaerythritol pentaacrylate | 524.51 |
| Polyethylene glycol diacrylate | e.g., with an average Mᵣ of 532 |
| Dipentaerythritol hexaacrylate | 578.60 |
| Polyalkylene glycol diacrylates | e.g., with an average Mᵣ of 360 to 2000 |

When molecular weight is referred to here, it means relative molecular weight (Mᵣ), i.e., the molecular mass normalized to one-twelfth of the mass of the carbon isotope ¹²C. Thus, the relative molecular weight has no unit of measurement.

According to the molecular weights given in the above table, the functionalizing reagent is preferably a small molecule with a molecular weight of from 90 to 2000, preferably of from 95 to 1100 and more preferably of from 95 to 600. This ensures that the molecular moiety between the vinyl groups (“spacer” 10, see FIG. 3) is as small as possible. The use of functionalizing reagents in this molecular size range ensures that the structures grafted onto the amino groups of the material surface also have a molecular weight in the range of 90 to at most 2000, preferably of 95 to at most 1100, and particularly preferably of 95 to at most 600. In the functionalized material surface, this results in the grafted vinyl groups being located as close as possible to the material surface. This appears to result in better anchorage and adhesion of the later applied layer of radiation-curing paint.

In addition, shorter spacers also minimize the likelihood that the functionalizing reagent will fold back onto the amino group-containing surface after grafting and that the second vinyl group also reacts with amino groups. This would otherwise run counter to the intended vinyl functionalization of the surface. For the same reasons, the functionalizing reagent according to the invention is also not intended to be a paint or a polymer.

### Painted Material

The vinyl functionalization of the amino group-containing surface described above results in a paintable material whose structured surface is retained even after painting. Accordingly, the invention also provides painted materials characterized by having a structured paint surface. These painted materials are obtainable by a method comprising the steps of
(a) providing a paintable material as previously described, i.e., a material having a structured surface of a plastic containing amino groups, in which at least a part of the amino groups on the structured surface of the plastic containing amino groups has been covalently functionalized with vinyl groups by grafting on a functionalizing reagent;
(b) applying a layer of radiation-curing paint to the structured surface of the material functionalized with vinyl groups,
(c) radiation curing of the paint layer.

Insofar as methods for achieving macroscopically structured paint surfaces are available at all in the prior art, they involve subsequent structuring of the paint surfaces. However, such methods have not gained acceptance due to insufficient practicality. For example, it has been proposed to apply a structuring film to the paint layer and then subsequently peel off this film. On the one hand, doing this it is very difficult to apply the structure exactly to match a decor present in the substrate. On the other hand, it is also difficult to introduce deeper structures without damaging the paint layer or underlying layers. To create deeper structures, as is necessary, for example, to imitate a wood structure, correspondingly thicker layers of paint must be applied. This not only has cost disadvantages, but in practice also usually means several successive paint applications in order to achieve the appropriate thicknesses of the layers.

Finally, subsequent surface structuring of a paint also results in defects in the paint surface and its microstructure. In other words, a subsequently structured paint surface is visually, both macroscopically and microscopically, very different from a paint surface structured according to the invention, which is intact. In the structured paint surface according to the invention, the surface structure goes back to the structure already present in the substrate, which is merely painted. According to the invention, the macroscopic structuring is present directly after painting and does not have to be subsequently introduced into the paint.

When “structured” surface or “structuring” is mentioned herein, macroscopic structuring is meant. This means a structure present in the surface, visible to the naked eye, which has an elevation and depth profile. The structuring is designed in three dimensions. The structured surface thus has a topography that can be felt with the bare hand when brushing over it, and which the eye of the beholder perceives as a structure. “Structure”, “structured surface”, “surface structure”, “topography”, and “elevation and depth profile” are used interchangeably herein.

The surface structure of the structured material or respectively paint surface according to the invention is in particular a decorative structure originally produced by embossing, laminating, calendering, etching, lasering or printing. The surface structure of the structured material or respectively paint surface is preferably a decorative structure visible to the naked eye. In a preferred embodiment, the surface structure of the structured material or respectively paint surface represents the surface structure of wood, natural stone, artificial stone, ceramics, metal, mosaics, floorboards, tiles, joints or any other decorative structure visible to the naked eye.

According to a particularly preferred embodiment, the paintable or painted material, respectively, has a decor, in particular a decor to which the structuring of the material or painted surface is matched. For example, if the decor is a wood decor, the structuring may consist of three-dimensional imitation of the woodcut topography, i.e., grooves along the depicted growth lines and depressions at depicted knotholes, etc.. If the decor is a tiled floor or a mosaic, the structuring can support this decor with depressions corresponding to the mapped joints.

In order to be perceived as a macroscopic structure by the naked eye, it is necessary that the depressions and elevations in the surface structure or respectively the topography are correspondingly very pronounced. The surface properties of materials are quantified by means of DIN EN ISO 4287 using the so-called profile method. The characteristic values Rz, Rz Max and Rt measured herein according to DIN EN ISO 4287 are determined as shown in FIG. 7 and are defined as follows. Rz: averaged difference of highest and lowest profile; Rz Max: highest measured point; Rt: total height of the profile (distance between the highest peak and the lowest valley of the profile over the entire evaluated length In).

According to a preferred embodiment, the structured material surface or respectively the structured paint surface has an Rz value, measured according to DIN EN ISO 4287, of at least 10 µm, particularly preferably at least 15 µm, and especially preferably at least 20 µm. This ensures that the structure is easily palpable and visible, and also distinguishes the surface structure according to the invention from the microstructure of the surface, which may have optical effects but cannot be perceived as a structure by the naked eye. The Rz value, measured according to DIN EN ISO 4287, is preferably at most 120 µm, particularly preferably at most 100 µm and especially preferably at most 80 µm.

According to an embodiment, the total layer thickness (measured after radiation curing) of radiation-curing paint in the painted material is at most half and preferably at most one third of the Rz value of the unpainted material surface. Preferably, the painted material does not contain any primer or undercoat layers. This ensures that the structuring present in the substrate is also retained as a structured paint surface in the painted material.

The person skilled in the art distinguishes between macroscopic structures and microscopic structures (so-called microstructures) in the case of surfaces. Macroscopic structures can be perceived as structures by the naked eye. These are meant when “structure” or “structuring” is mentioned in this description. In contrast, microstructures, as the name implies, are only visible with a microscope. Particularly advantageous microstructures can be created in a paint surface by means of excimer curing, for example. The invention allows, for example, macroscopically structured aminoplast resin surfaces to be combined with an excimer-cured paint layer.

Excimer curing is well known to a person skilled in the art and is widely used in practice for the matting of paint surfaces. The matting process is purely physical and does not require the addition of any matting agents. Excimer curing is based on the following principle: In radiation-curing paints (e.g., acrylates), free radicals are formed by the 172 nm excimer lamp (e.g., Excirad 172) that trigger a polymerization and crosslinking. The penetration depth of the 172 nm photons into the acrylates is between 0.1 and 0.5 nm, so that only a very thin surface layer is crosslinked. The shrinkage caused by polymerization results in microstructures. A wrinkled skin floats on the fluid film, which is subsequently completely cured with a second radiation source. An Hg-UV lamp, an electron radiator, or a long-wavelength excimer lamp at 308 nm can be used for this purpose. To avoid ozone formation, irradiation takes place in a nitrogen atmosphere.

The physical microfolding produced with the 172 nm excimer lamp allows gloss values of 1 to 10, measured e.g., according to EN ISO 2813 with the 60° geometry, to be easily achieved in radiation-curing paints without the addition of matting agents. The high-energy and short-wavelength 172 nm radiation results in additional crosslinking of the monomers in addition to the radical polymerization of the acrylate groups. This increases the surface hardness considerably. The inventors have also found that excimer curing produces a beneficial anti-fingerprint effect on paint surfaces.

The structured paint surface provided according to the invention can be combined in a particularly advantageous manner with a microstructure, in particular a microstructure produced by excimer curing, in the paint surface. According to a preferred embodiment, the painted material is characterized in that the paint layer is an excimer-cured paint layer.

By using such an excimer curing or selecting a corresponding matte paint, it is possible according to the invention to obtain structured paint surfaces that have a gloss value of below 10, preferably below 5, in each case measured according to ÖNORM EN ISO 2813 (version 2015-01-01) with the 60° geometry.

The common plastics containing amino groups, especially aminoplast resins, are not amenable to excimer curing. However, decorative structures can be imprinted particularly well in their surfaces during production, e.g., by appropriately structured rolls or press sheets. The invention makes it possible to combine macroscopic surface structures, e.g., created by embossing, with excimer curing in the course of painting. This results in structured material surfaces that have an exceptionally natural mattness and, when combined with appropriate decors and structuring (e.g., flooring laminate as imitation wood flooring), can no longer be distinguished from the material to be imitated (e.g., real wood parquet). By means of appropriate microstructuring of the paint surface or the use of a corresponding paint, the invention also makes it possible for the first time to equip macroscopic surface structures, e.g., those produced by embossing, with anti-fingerprint properties.

This is made possible by the fact that, according to the invention, the vinyl functionalization of the material surface makes it possible to dispense with the primer coat or undercoat or filler otherwise required when painting plastics containing amino groups, in particular aminoplast resins, with radiation-curing paints. In the prior art, these result in layer thicknesses in the paint structure regularly exceeding 20 or 30 g/m². Any structuring of the surface present in the substrate, as is common, for example, when imitating wood structures and decors, is inevitably evened out and thus nullified when such a thick paint application is applied. For this reason, the prior art has so far refrained, for example, from painting structured aminoplast resin surfaces, as is common in laminate or furniture board production.

The painted material according to the invention is characterized in that the applied layer of radiation-curing paint or paints is so thin that any structuring present in the substrate is substantially retained. According to the invention, this is made possible by the fact that, because of the vinyl functionalization, there is no need for corresponding primer or undercoat layers. For example, the painted material typically does not contain a paint primer or undercoat layer. The radiation-curing paint applied to the vinyl-functionalized surface can therefore also directly be a topcoat. It would otherwise only adhere to the common plastics containing amino groups, in particular aminoplast resins, if they were pre-painted with appropriately formulated paint primers or undercoats.

According to a particularly advantageous embodiment, the amount of radiation-curing paint applied in total to the plastic surface of the paintable material is less than 20 g/m², in particular less than 15 g/m² or less than 10 g/m². In the painted material according to the invention, the average layer thickness of the paint layer of radiation-curing paint located on the structured plastic surface is preferably 0 to 50 µm, particularly preferably from 5 to 35 µm, and most preferably from 5 to 15 µm. The layer thickness is measured microscopically using cross-sections according to DIN EN ISO 1463 (August 2004). The low paint application amounts and thicknesses made possible by the invention lead to the surface structuring present in the substrate (the paintable material) also being retained in the painted material in the form of a structured paint surface.

### Radiation-Curing Paint

Due to the vinyl groups inserted into the surface of the paintable material, it is optimally prepared for subsequent painting with a radiation-curing paint. This is because most radiation-curing paints cure themselves via vinyl group-mediated radical polymerization. Thus, the vinyl groups in the material surface provide covalent anchoring points for the radiation-curing paint, resulting in excellent adhesion of the paint to the material surface.

The radiation-curing paint can be applied to the structured surface of the paintable material functionalized with vinyl groups by any method known to the person skilled in the art. In particular, the application can be performed by rolling, spraying, gunning, flooding, dipping, casting, doctoring and/or brushing on.

By selecting the radiation-curing paint, the desired gloss level and surface properties can be flexibly and specifically adjusted. Partial matte/gloss effects or matte/gloss gradations matched to the decorative image can also be achieved by selecting a suitable radiation-curing paint. Preferably, the radiation-curing paint has a gloss value of below 10, preferably below 5, in each case measured according to ÖNORM EN ISO 2813 (version 2015-01-01) with the 60° geometry, after curing.

Radiation-curing paints are known to the person skilled in the art and are described, for example, here: Prieto and Keine, “Holzbeschichtung”, FARBE UND LACK, 2019, chapter 3.1.6 – Strahlenhärtende Lackysteme. A “radiation-curing paint”, as used herein, is a paint containing film formers having carbon-carbon double bonds that undergo radical polymerization upon exposure to ultraviolet light (UV) or ionizing radiation (ESH). Preferably, the carbon-carbon double bonds are acrylic double bonds, i.e., those derived from acrylic or methacrylic acid or derivatives of these compounds. In UV curing, photoinitiators must be added to generate the starting radicals necessary for polymerization. In addition to the film former, the radiation-curing paint usually contains reactive diluent and photoinitiator and, if necessary, other additives selected from the group consisting of pigments, fillers, matting agents, defoamers, silicone oils, and inhibitors or stabilizers.

According to one embodiment, the radiation-curing paint is a radiation-curing acrylate resin. Due to their property profile, in particular the simultaneous fulfillment of mechanical (e.g., hardness, abrasion resistance, scratch resistance and/or wear resistance) and optical requirements, these are commonly used in paint compositions intended for surface refinement. Preferably, the radiation-curing acrylate resin used is dipropylene glycol diacrylate (DPGDA) and/or poly(propylene glycol) diacrylate (PPGDA). Other radiation-curable acrylate resins that can be used according to the invention are marketed, for example, by BASF under the “Laromer®” brand. Whenever “acrylate” is mentioned herein, it always also comprises the corresponding methacrylate derivative.

By reactive diluent, the person skilled in the art understands polymerizable, radiation-curing monomers which are added to the radiation-curing paint for viscosity reduction. In contrast to a classic solvent, the reactive diluents react during radiation curing in the radical polymerization and are thus incorporated into the paint film as monomers. Particularly good results can be achieved with monomeric (meth)acrylic acid esters as reactive diluents, which are liquid at room temperature. Examples of such compounds include isobornyl acrylate, hydroxypropyl methacrylate, trimethylolpropane formal monoacrylate, tetrahydro-furfuryl acrylate, phenoxyethyl acrylate, trimethylolpropane triacrylate, dipropylene glycol diacrylate, tripropylene glycol diacrylate, hexanediol diacrylate, pentaerythritol tetraacrylate, dipentaerythritol pentaacrylate, lauryl acrylate and propoxylated or ethoxylated variants of these reactive diluents. Urethanized reactive diluents such as EBECRYL 1039 (Cytec) or other compounds that are liquid at room temperature and capable of reacting under conditions of radical polymerization, e.g., vinyl ether or allyl ether, can also be used. Preferred vinyl ethers are diethylene glycol divinyl ethers, triethylene glycol divinyl ethers or cyclohexanedimethanol divinyl ethers. The radiation-curable paint may contain reactive diluents in an amount of 1-70 wt.%.

Preferably, the film former in the radiation-curable paint is selected from unsaturated polyesters, epoxy acrylates, polyester acrylates, polyether acrylates, amino-modified polyether acrylates and urethane acrylates. As unsaturated polyesters (UP), in particular those based on maleic acid, may be considered. In practice, these are often combined with styrene as a reactive diluent.

In order to be UV-cured, radiation-curable paints must contain photoinitiators. A wavelength of 200 nm would be required for homolytic cleavage of the C═C double bond. The commercially available UV lamps emit in this wavelength range only to a very small extent. In addition, this range of radiation is absorbed by air, creating ozone. Photoinitiators are radical formers capable of absorbing the higher-emission, longer-wave range of the UV lamp. The radicals thus formed then trigger the radical polymerization of the reactivated components of the UV paint (film former and, if necessary, reactive diluent). Photoinitiators may be selected, for example, from the group consisting of alpha-hydroxyketones, 1-hydroxycyclohexyl phenyl ketone, benzophenone, thioxanthones, benzoin, benzoin ethers, benzilketals, aminoalkylphenones, hydroxyalkylphenones, monoacylphosphine oxides and bisacylphosphine oxides and derivatives thereof. If the radiation-curable paint contains pigments or other absorbing substances, these and the photoinitiator used must be selected and matched with respect to the absorbed wavelength ranges.

The invention is described in more detail below by way of examples of embodiments with reference to the accompanying drawings. The examples serve only to illustrate the invention and do not limit the scope of protection.

### BRIEF DESCRIPTION OF THE DRAWINGS

FIG. 1: shows a paintable or painted material according to the invention, which is board-shaped and whose surface has a structuring that imitates a wood grain,

FIG. 2: shows cross-sections through various paintable board-shaped materials according to the invention to illustrate the structure of these materials and their surface layers, with FIG. 2a showing a laminate, FIG. 2b a layered material and FIG. 2c a wooden material,

FIG. 3: shows a schematic detailed view of the material surface made from a plastic containing amino groups, showing how an amino group present there can react with the functionalizing reagent according to the invention to result in a vinyl functionalization of the material surface,

FIG. 4: shows cross-sections through various board-shaped materials painted according to the invention, wherein the materials in question are those shown in FIG. 2, the surface of which has been functionalized according to the invention and then painted with a radiation-curing paint,

FIG. 5: shows schematic representations of the structured material surface before and after painting and, if necessary, functionalization, FIG. 5a showing a structured material surface before any functionalization or painting, FIG. 5b showing a surface primed or respectively undercoated according to the state of the art and then painted, FIG. 5c showing a paintable material surface functionalized with vinyl groups according to the invention, and FIG. 5d showing a functionalized surface after painting as shown in FIG. 5c,

FIG. 6: shows a schematic representation of the production process for the paintable or respectively painted material according to the invention.

FIG. 7: shows an example profile to explain the roughness parameters R_{z} and Rₜ used here.

List of reference signs

| | |
|---|---|
| 1 | Material |
| 1′ | Paintable material |
| 1″ | Painted material |
| 2 | Surface made of a plastic containing amino groups |
| 3 | Structuring |
| 4 | Uppermost layer |
| 5 | Carrier board |
| 6 | Backer |
| 7 | Core |
| 8 | Functionalizing reagent |
| 9 | Vinyl group |
| 10 | Spacer |
| 11 | Covalent bond |
| 12 | Layer of radiation-curing paint |
| 13 | Primer or undercoat layer |
| 14 | First feed conveyor belt |
| 15 | Second feed conveyor belt |
| 16 | Third feed conveyor belt |
| 17 | Belt conveyor system |
| 18 | Melamine resin impregnated decorative paper |
| 19 | Melamine resin impregnated overlay paper |
| 20 | Press stack |
| 21 | Short-cycle press |
| 22 | Structured press sheet |
| 23 | Apparatus for applying the functionalizing reagent |
| 24 | First radiation source |
| 25 | High-energy radiation |
| 26 | Apparatus for applying of the radiation-curing paint |
| 27 | Excimer radiation source |
| 28 | Excimer radiation |
| 29 | Second radiation source |
| 30 | Feeding conveyor belt |

### DESCRIPTION OF THE INVENTION

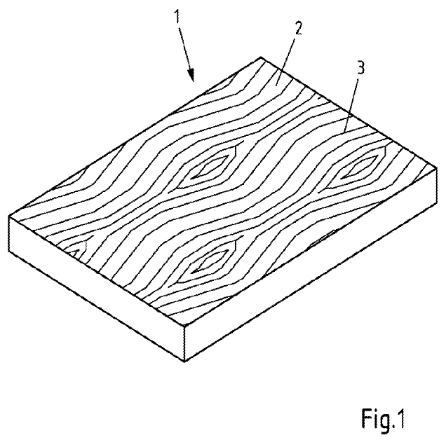

FIG. 1 shows a plan view of a paintable or painted material 1 according to the invention. In both cases, the characteristic structuring 3 of the surface can be seen (structured surface of plastic containing amino groups or structured paint surface), which in the embodiment shown simulates a wood grain. The material 1 is board-shaped and may have a decor (e.g., a wood decor) that is consistent with the structuring 3. The material 1 has a surface made of a plastic containing amino groups 2, into which the structuring 3 is introduced.

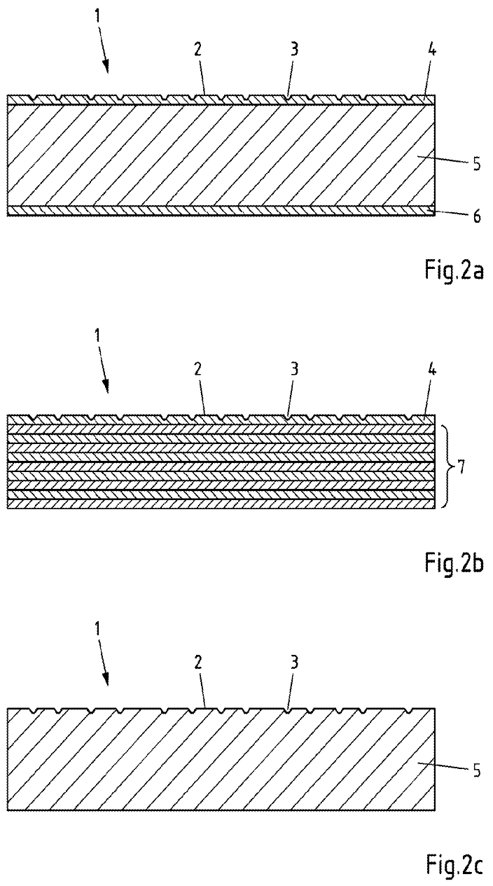

FIG. 2 shows cross-sections through three exemplary materials 1 that can be used according to the invention and may look as shown in FIG. 1 in plan view. The material 1 shown in FIG. 2a is a laminate consisting of a carrier board 5, an underlying backer 6 and an overlying uppermost layer 4. The backer 6 is typically a paper soaked in synthetic resin, which is used to equalize the tensions on the top and bottom side. The carrier board 5 can be a wooden material board, such as an MDF or HDF board. However, it can also be a plastic or compact board made of kraft papers impregnated with phenolic resin. The uppermost layer 4 typically consists of at least one melamine resin impregnated decorative paper and an overlying melamine resin impregnated overlay, which have been hot pressed together with the carrier board 5 and the backer 6 to form the material 1. This causes the layers of the laminate to bond together and the melamine or synthetic resin to cure. On the upper side of the uppermost layer 4 of material 1, there is a surface of a plastic containing amino groups 2 because of the cured melamine resin present there. The amino groups are terminal remaining primary amino groups and the secondary amino groups of the cured melamine resin (melamine-formaldehyde resin).

Also visible in the cross-section is the structuring 3 of the surface already shown in plan view in FIG. 1, which is shown here schematically as indentations, as can be produced for example with structured press sheets. However, it is of course also possible to apply structuring measures (e.g., 3D printing), which would then result in elevations in the surface or a combination of elevations and depressions. The shown surface of plastic containing amino groups 2 may already have been functionalized with vinyl groups according to the invention, in which case the material 1 is a paintable material 1′ according to the invention. Otherwise, the material 1 shown is the starting material for the method according to the invention for producing the paintable material 1′.

The material 1 shown in FIG. 2b represents a layered material, e.g., a compact board. The core 7 is formed by a stack of phenolic resin impregnated kraft papers (e.g., 90 layers), and the uppermost layer 4 can again be a melamine resin impregnated decorative paper and an overlying melamine resin impregnated overlay, as in FIG. 2a, which together with the core 7 of impregnated papers have been hot pressed to form the material 1. What has already been said about FIG. 2a applies accordingly to the other characteristics.

As shown in FIG. 2c, the material 1 can also be just a carrier board 5 provided with structuring 3. Said carrier board has a surface made of a plastic containing amino groups 2. The carrier board 5 may, for example, be made of or coated with the plastic containing amino groups. The carrier board 5 may also be a wooden material board (e.g., particleboard, fiberboard or OSB board) obtained from particles containing lignocellulose which have been glued with an aminoplastic binder and pressed to form the wooden material board. The amino groups on surface 2 are then terminal remaining primary amino groups and the secondary amino groups of the cured aminoplast resin. The carrier board has structuring 3 at least on the top surface 2. What has been said for FIG. 2a applies accordingly.

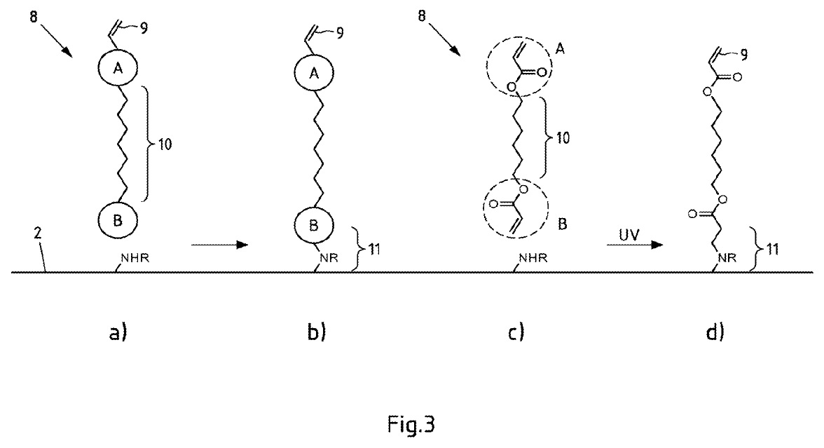

FIG. 3 schematically shows a detailed view of the reactions that occur on the surface of a plastic containing amino groups 2 shown in FIGS. 1 and 2 during functionalization with the functionalizing reagent 8 according to the invention. In FIG. 3a and FIGS. 3c, a single secondary amino group (-NHR) is shown representatively in each case in the surface made of a plastic containing amino groups 2. It goes without saying that the surface made of a plastic containing amino groups 2 will contain many such secondary, but also primary amino groups (—NH₂), each of which can also react appropriately with the functionalizing reagent 8. The functionalizing reagent 8 has at least three molecular moieties: (1) a first functional group A, which has a vinyl group 9, (2) a second functional group B, this being a group reactive toward the amino groups of the plastic containing amino groups, and (3) the intervening molecular moiety, referred to herein as the “spacer” 10. In case of more complex molecules, the spacer length denotes the shortest path between groups A and B. Preferably, the spacer length is between 2 and 20 carbon atoms, in particular between 2 and 10 carbon atoms, although other heteroatoms may be present between the carbon atoms. The functionalizing reagent 8 is thus an at least bifunctional molecule, since it has at least the functional groups A and B.

In FIGS. 3a and 3b, the functionalizing reagent 8 is shown only schematically. The functional group A shown in FIG. 3a may be any functional group comprising a vinyl group 9. Group A can also consist of a vinyl group. The functional group B shown in FIG. 3a may be any group reactive toward the amino groups of the plastic containing amino groups. Group B may be, for example, an epoxide, acid anhydride, acid chloride, acid azide, sulfonyl chloride, ketone, aldehyde, carboxylic acid, ester, especially N-hydroxysuccinimide ester, imido ester, or carbonates, carbodiimide, isocyanate, isothiocyanate, alkyl halide, aryl halide, alkyne, or a vinyl group, such as acrylate, methacrylate, or acrylamide. In FIGS. 3c and 3d, hexanediol diacrylate (HDDA) is shown as an example of a specific functionalizing reagent 8. In this symmetrically structured molecule, both group A and group B are acrylate groups. The spacer 10 here consists of six —CH₂—groups.

According to the invention, the functionalizing reagent 8 is applied to the surface made of a plastic containing amino groups 2, resulting in the arrangement shown schematically in FIGS. 3a and 3c. By setting the appropriate reaction conditions, a reaction occurs at the surface 2 between amino groups present there and the reactive group B of the functionalizing reagent 8, and thus the functionalizing reagent is grafted onto an amino group at the surface of the plastic containing amino groups, forming a covalent bond 11 as shown in FIGS. 3b and 3d. The surface 2 has thus been covalently functionalized with vinyl groups 9, which are now available there for reaction with, for example, a radiation-curing paint. FIGS. 3b and 3d) thus show a detailed view of the functionalized surface of a paintable material 1′ according to the invention.

The reaction conditions, which are symbolically represented by a reaction arrow between FIGS. 3a and 3b or respectively 3c and 3d, depend strongly on the nature and chemistry of the reactive group B in the functionalizing reagent. If the reactive group B is a vinyl and in particular an acrylate group, irradiation with high-energy radiation such as electron beams or UV light is sufficient for the aza-Michael addition shown in FIGS. 3c and 3d to occur.

The material surfaces functionalized with vinyl groups can then be painted or stored. When a non-reversible reaction is chosen for functionalization (e.g., aza-Michael addition), material surfaces functionalized with vinyl groups have proven to be well storable. However, it is also advantageous to further process the functionalized material surfaces directly, in particular to paint them, since in this case, excess functionalizing reagent does not interfere and, on the contrary, can be directly incorporated by polymerization into the paint layer. In the case of storage, it is recommended to take precautions to avoid soiling or smearing, such as individual board storage, storage with intermediate layer or cleaning off the excess. According to a preferred embodiment, functionalization with vinyl groups is immediately followed by painting of the functionalized material surface.

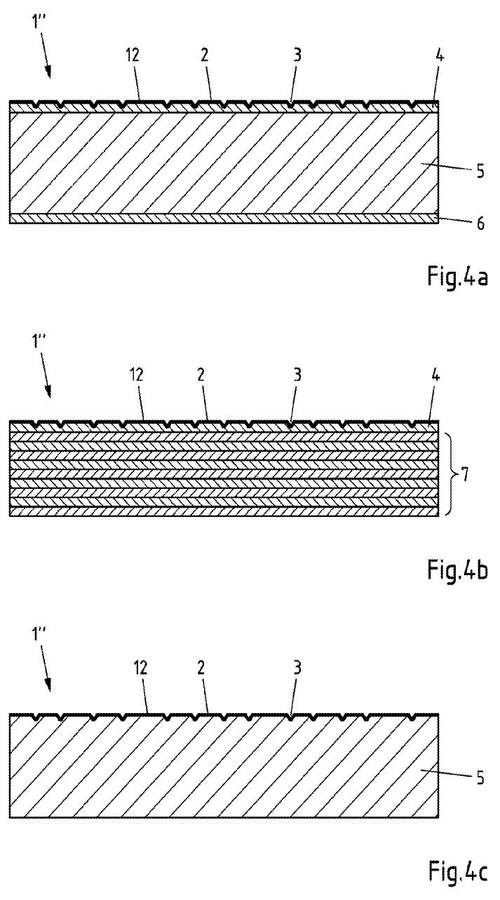

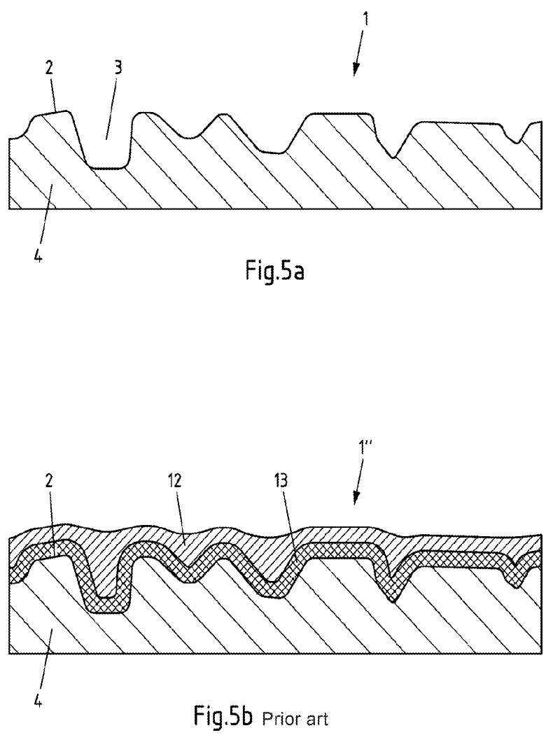

If painted directly, it does not interfere because the reagent is incorporated by polymerization. FIGS. 4a – 4c show the materials already discussed in connection with FIGS. 2a – 2c, but this time after vinyl functionalization according to the invention and subsequent painting. Directly on top of the uppermost layer 4, which has been functionalized with vinyl groups (not shown), there is now a layer of radiation-curing paint 12. For example, a commercially available acrylate topcoat can be applied directly to a structured melamine resin surface functionalized according to the invention in a layer thickness of 5-15 g/m². The fact that primers or undercoats can be dispensed with according to the invention means that the paint layer 12 can be applied in such a thin layer that the structuring 3 present in the uppermost layer 4 of material 1 is retained even after painting (compare FIGS. 2a – 2c before painting with FIGS. 4a – 4c after painting). It is thus possible, for example, to obtain structured aminoplast resin surfaces, such as those shown schematically in plan view in FIG. 1, in painted form. The inventors have surprisingly found that when such a surface structuring 3 is combined with a matte paint 12 or an excimer curing of the paint layer 12, natural-looking material surfaces that are virtually indistinguishable from the original (e.g., real wood parquet) in terms of appearance, feel and temperature sensation, while having improved surface properties (e.g., micro-scratch, weathering and chemical resistance) are created.

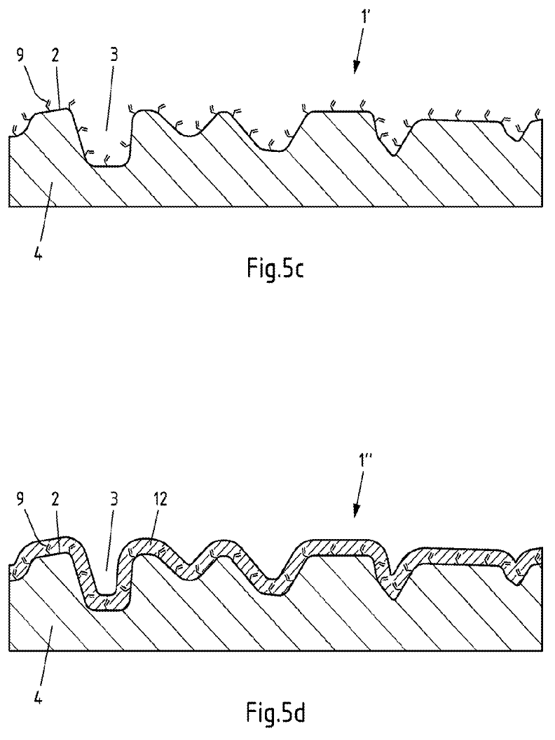

FIG. 5 serves to illustrate the advantages of the invention compared to the prior art. FIG. 5a shows an enlargement of the cross-section through the uppermost layer 4, such as can also be seen in FIGS. 2a – 2c. The uppermost layer 4 has a structuring 3 and is made of or contains a plastic containing amino groups (e.g., a melamine resin), providing it with a surface of plastic containing amino groups 2. If such a melamine resin surface were to be painted with a radiation-curing paint 12 according to the prior art (e.g., an acrylate paint), a primer or undercoat layer 13 would first have to be applied to the structured melamine resin surface, since radiation-curing paints adhere very poorly to it. The multi-layer paint structure 12, 13 results in a considerable paint layer thickness -compared to the largest elevation and depth difference in structuring 3 (Rz value). Overpainting causes the structuring to be lost. According to the prior art, it therefore makes no sense, for example, to paint over a melamine resin surface having a wood structure (cf. FIG. 1), as is frequently used, for example, as a furniture surface or flooring laminate. Such painting would nullify any structuring that was originally introduced.

By contrast, the invention makes it possible to paint over structured aminoplast resin surfaces. FIG. 5c shows a paintable surface according to the invention, similar to FIG. 5a as an enlargement of the cross-section through the uppermost layer 4, as also shown for example in FIGS. 2a – 2c. As in FIG. 5a, the uppermost layer 4 in FIG. 5c also has a surface of plastic containing amino groups 2, into which a structuring 3 has been introduced. However, as is apparent from a comparison of FIG. 5a with 5c, the paintable material 1′ according to the invention in FIG. 5c has a surface functionalized with vinyl groups 9 (see also FIGS. 3b and 3d). As shown in FIGS. 5d, a layer of radiation-curing paint 12 can be applied directly to this surface functionalized with vinyl groups 9 according to the invention, without first having to apply a primer or undercoat layer 13. FIG. 5d shows the applied layer of radiation-curing paint even before radiation curing, as can be seen from the vinyl groups 9 still being present. During the radiation-induced radical polymerization of the paint layer 12, the vinyl groups 9 present on the surface 2 polymerize into the paint film, which is thereby covalently anchored in the uppermost layer 4 of the material. This explains the observed excellent adhesion of radiation-curing paints to the paintable material surfaces provided by the invention. Since the vinyl groups 9 introduced into the surface 2 react into the paint during radiation-curing, they are no longer detectable following radiation-curing of the paint layer 12. In cross-section, therefore, a material painted according to the invention simply appears as if no primer or undercoat layer had been used. Only the paint film itself is visible on the substrate.

In contrast to the prior art (see FIG. 5c), according to the invention, when a structured material surface is painted, its structuring is retained even after painting, since substantially lower paint layer thicknesses can be achieved if the primer or undercoat layer is omitted. FIG. 5d therefore shows the structured paint layer present in the painted material according to the invention, which corresponds to the structuring of the material surface before painting (cf. FIGS. 5a or 5c with FIG. 5d).

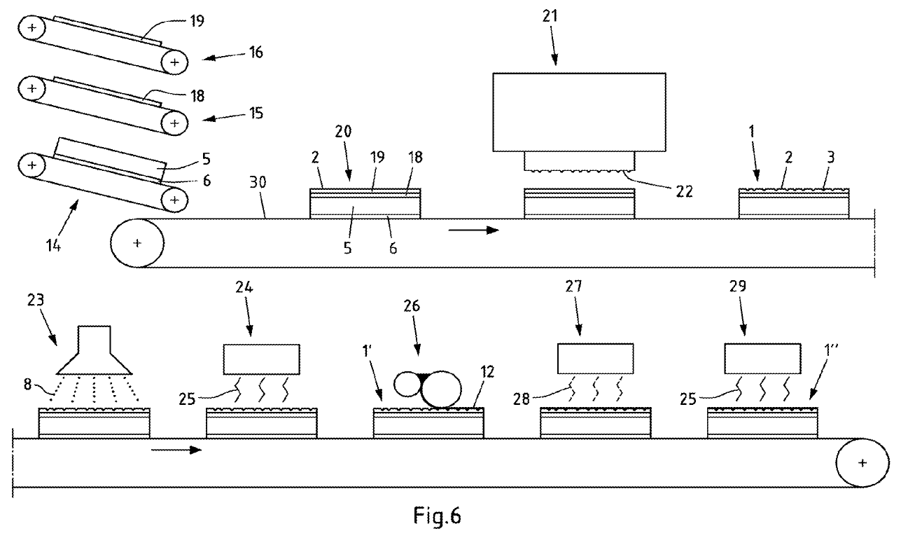

FIG. 6 shows an example of a system and a method for producing a paintable material according to the invention, which is then directly further processed to a painted material according to the invention. Via a first, second and third feed conveyor belt 14, 15, 16, a wooden material board as carrier 5 with backer 6 on the underside (shown as liquid backer attached to the underside, the latter can also be fed via a separate fourth feed conveyor belt) as well as a melamine resin impregnated decorative paper 18 and melamine resin impregnated overlay 19 are placed on a feed conveyor belt 30 as press stack 20. For simplicity, the feed conveyor 30 is drawn as a continuous conveyor belt. In practice, however, this involves several separate conveyor belts whose speeds and surface properties are adapted to the respective method step. The press stack 20 then passes through a short-cycle press 21, which is equipped with a structured press sheet 22 on the side facing the overlay paper. In this example, the structure provided in the press sheet is the negative image of the wood grain shown in FIG. 1. In the short-cycle press, the press stack is pressed at 180° C. to 230° C. and a specific pressing pressure (active pressure on the board surface) of 50 to 300 N/cm² to form material 1, which is a laminate panel having a surface 2 containing amino groups and provided with a structuring 3. Both terminal primary amino groups and secondary amino groups are present in the cured melamine resin at surface 2. Material 1 corresponds to a material having a structured surface known from the prior art, as it is produced in many variations as flooring or furniture components and is already available in intermediate stock.

The production of material 1 is therefore shown in the upper part of FIG. 6 for the sake of completeness only. Material 1 is storable and the method can be interrupted here. Above all, the numerous materials 1 already available with structured surfaces 2, 3 containing amino groups can be used in practice. These can be introduced to the method according to the invention for surface functionalization with subsequent painting without pretreatment. This is another advantage of the solution according to the invention.

The material 1 with structured surface 2, 3 containing amino groups is fed to an apparatus 23 for applying the functionalizing reagent 8 according to the invention. In the embodiment shown, a functionalizing reagent having two acrylate groups is used (e.g., dipropylene glycol diacrylate, tripropylene glycol diacrylate, or hexanediol diacrylate). In the apparatus 23, the functionalizing reagent 8 is applied to the structured surface 2, 3 containing amino groups of the material 1. In FIG. 6, the application of the functionalizing reagent 8 in the apparatus 23 is shown as spraying. However, numerous alternative application methods are also possible as detailed in the description, in particular application via a roller as shown in FIG. 6 for the apparatus for applying the radiation-curing paint 26.

In the next step, the applied functionalizing reagent 8 is caused to react with the amino groups on the surface 2 of the material by setting the appropriate reaction conditions. If the group in the functionalizing reagent that is reactive toward the amino groups of the material surface is a vinyl group, in particular one that is adjacent to an electron-withdrawing group (such as in an acrylate group), the reaction can take the form of a radiation-induced aza-Michael addition.

For this purpose, the surface 2 of material 1 containing amino groups and to which functionalizing reagent 8 has been added is exposed to a radiation source 24. The high-energy radiation 25 (e.g., UV or electron beams) impinges on the surface 2, where it leads to an aza-Michael addition of an acrylate group of the functionalizing reagent 8 to amino groups in the surface 2 (cf. FIGS. 3a - 3d). The functionalizing reagent 8 is thereby grafted onto the surface 2 of the material, resulting in covalent functionalization of the surface 2 with vinyl groups. The material 1′ functionalized in this manner constitutes the paintable material of the invention.

The paintable material 1′ can be painted with a radiation-curing paint 12 directly afterwards or in a separate method. For this purpose, the material 1′ passes through an apparatus 26 for applying the radiation-curing paint 12. FIG. 6 shows the application of the paint in apparatus 26 by a roller, however, all methods otherwise known to the person skilled in the art for applying radiation-curing paints are also possible. The applied layer 12 of radiation-curing paint is then cured by high-energy radiation 25, 28 in a manner known from the prior art. In the system shown in FIG. 6, an upstream excimer radiation source 27 is provided in addition to the second radiation source 29 actually required for curing (e.g., a UV lamp or an electron radiator). In this process, the applied paint layer is exposed to excimer radiation 28 (172 nm), resulting in the microstructuring of the paint surface described in more detail in the description. The resulting paintable material 1″ thus not only has a macroscopically structured paint surface corresponding to the surface structuring 3 present in the paintable material (e.g.,

wood grain, see plan view in FIG. 1), but also an additional microstructuring which produces a special matt finish and also gives the surface of material 1″ anti-fingerprint properties.

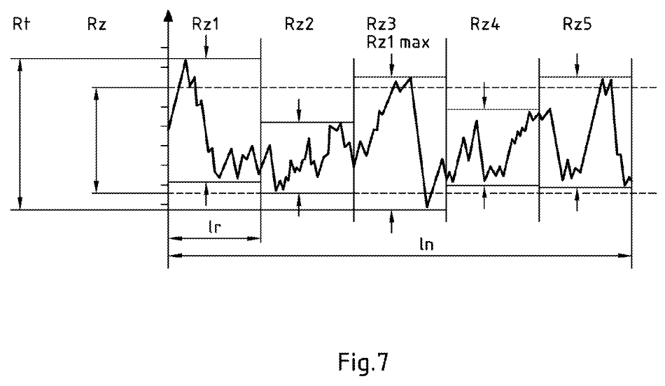

FIG. 7 shows a diagram illustrating the determination of the characteristic values Rz, Rz Max and Rt measured according to DIN EN ISO 4287. Where Rz means: averaged difference of highest and lowest profile (average of the five Rz values shown 1 to 5); Rz Max: highest measured point (largest Rz value determined); Rt: total height of the profile (distance between the highest peak and the lowest valley of the profile over the entire evaluated length In).

### Exemplary Embodiments

Industrially manufactured laminate flooring or furniture surface panels having a structured melamine resin surface from the production of the EGGER company were used in all exemplary embodiments. These were CPL boards having the following layer structure: Backer, MDF core, melamine resin impregnated decorative and overlay paper, with the subsequent structures having been embossed into the latter during pressing by means of appropriately designed press sheets:
ST67 F870 Slate decorative paper, trade name “CERAMIC”, with irregular rough character (all-over structure/no synchronous structure)
ST69 “Natural Pore” decorative paper – Authentic, true-to-decor wood grain in combination with synchronously running surface structure
ST28 “Gladstone Oak” decorative paper (look of classic planked oak), in combination with the synchronous surface structure ST28 Feelwood Nature (feel of sandblasted oak).
F1 wood grain in all-over structure

### Test Series 1

As indicated in the table below, the structured melamine resin surfaces of the boards were either not subjected to any treatment at all (comparative examples 1, 3, 5 and 8) or 0.5 g/m² of hexanediol diacrylate (HDDA) was applied by roller application and then irradiated with a UV lamp (examples 2, 7 and 10 according to the invention; irradiation was performed with an 80 watt mercury lamp, at a 10 m/min feed rate with the dose of UV-A >350 mJ/cm²) or a commercially available UV primer for melamine resin surfaces (ICA UVF5782) was applied in an amount of 4 or 4–5 g/m² by roller application and was partially gelled by UV irradiation (comparative examples 4, 6 and 9; irradiation was also performed with an 80 watt mercury lamp, at 10 m/min feed rate with the dose of UV-A >350 mJ/cm²). The surfaces, which were vinyl-functionalized with HDDA according to the invention or primed according to the prior art, were then painted with commercially available UV topcoat compositions (acrylate coating, ICA UVS5595) and UV cured according to the manufacturer’s instructions. For this purpose, after the topcoat application at 15 m/min, excimer curing (company IST) was performed first, followed by double irradiation with 120 W mercury lamps for final curing.

The gloss value under 60° and 85° was determined according to ÖNORM EN ISO 2813 (version 2015-01-01). The surface condition was also determined using the profile method according to DIN EN ISO 4287 (October 1998 version). The definition of the Rz value is as given in the description and in FIG. 7.

The adhesion was determined by means of “Hamberger Hobel”, a standardized testing device from Hamberger Industriewerke, with which a coin test can be performed under defined conditions. A metal piece with a coin-like edge is pushed over the painted area with an adjustable pressure. The result is the force in newtons at which no stress whitening is yet detectable. All results above 15 newtons can generally be considered acceptable.

The following test results were obtained:

TABLE 2

| Sample | | Functionalization with vinyl groups | UV primer | UV topcoat | Gloss 60° | Gloss 85° | Rz | Δ Rz | Hamberger Hobel |
|---|---|---|---|---|---|---|---|---|---|
| 1* | ST67 | - | - | - | 6.2 | 12.8 | 21.3 | | >40 N |
| 2 | ST67 | 0.5 g/m² HDDA, UV | - | 7 g/m² | 3.2 | 6.9 | 24.9 | 3.6 | >40 N |
| 3* | ST 69 | - | - | | 5.2 | 10.6 | 61.1 | | >40 N |
| 4** | ST 69 | - | 4 g/m² | 12 g/m² | 1.8 | 14.2 | 22.1 | 39.0 | < 15 N |
| 5* | ST 28 | - | - | - | 4.1 | 10.8 | 55.1 | - | > 30 N |
| 6** | ST 28 | - | 4-5 g/m² | 7-8 g/m² | 5.8 | 32.1 | 43.7 | -11.4 | < 10 N |
| 7 | ST 28 | 0.5 g/m² HDDA, UV | - | 7 g/m² | 3 | 11.2 | 70.9 | 15.8 | >30 N |
| 8* | F1 | - | - | - | 8.4 | 23.2 | 35.1 | | >40 N |
| 9** | F1 | - | 4-5 g/m² | 7-8 g/m² | 7.6 | 28.4 | 28.4 | -6.7 | < 15 N |
| 10 | F1 | 0.5 g/m² HDDA, UV | - | 7 g/m² | 3.1 | 12.3 | 38.0 | 2.9 | >40 N |

* Not according to the invention (starting product, structured melamine resin surface)
** Not according to the invention (over painted with UV primer and UV paint)

A comparison of samples 1* and 2 shows that with the functionalization according to the invention it is possible to apply a UV paint directly to a melamine resin surface without any deterioration of the adhesive bond (Hamberger Hobel Coin Test). By using a matte UV paint, the unnaturally high-gloss melamine resin surface can be given a matte appearance (gloss 60° at approx. 3, cf. examples 2, 7 and 10 according to the invention with the corresponding melamine resin surfaces 1*, 5* and 8*) and yet its structured surface matching the decor can be retained or even enhanced (difference [Δ] in the Rz values unchanged to positive in examples 2, 7 and 10 according to the invention). In contrast, the application of a layer of standard UV primer followed by painting results in a strong decrease of the Rz value after painting (see negative difference [Δ] of the Rz values in the comparative examples 4**, 6** and 9**) even with the relatively thin layer thicknesses used (usual for UV primers up to 10 g/m², and for topcoats up to 15 g/m²).

In addition, the micro-scratch resistance of the surfaces was determined according to DIN EN 16094 (Martin Dale standard for flooring). (Rating 1-5; 1 best rating, 5 worst rating)

| | | |
|---|---|---|
| | Surface – not painted, (samples 1*, 3*, 5* and 9*) | Surface – painted (samples 2, 7 and 10) |
| Martin Dale Test A | >A2 | A1 |
| Martin Dale Test B | >B3 | B1 |

While the unpainted melamine resin surfaces were very susceptible to micro-scratches, the micro-scratch resistance could be significantly increased by the painting according to the invention, while retaining the original structuring.

The evaluation of samples 1 to 10 was also performed in a blind test by trained experts of the company EGGER. This evaluation showed that samples 2, 7 and 10 according to the invention had by far the most natural appearance of all 10 samples and could hardly be distinguished from the original to be imitated (veneer/real wood surface, stone/ceramic decors or respectively textile decorative pattern with smooth structure) in terms of their appearance as well as their feel and touch temperature.

### Test Series 2

Similar results to those obtained with the UV primer ICA UVF5782 and topcoat ICA UVS5595 used in test series 1 were also obtained in numerous tests with other commercially available UV primers (tested: Plantag 74170, Remmers UV120-112, Teknos E114203, Sherwin Williams UL/61099-469, Votteler L5405524) and topcoats (tested: Plantag 75773.6, Teknos E120239, Bergolin 2U073, Bona 7720, Akzo Nobel UV TOP 103939). The vinyl functionalization according to the invention was always superior to the commercially available UV primers due to the lower layer thickness and better adhesion.

### Test Series 3

A test series was performed as described for test series 1, except that BDDA was used as the functionalizing reagent instead of HDDA. The results were similar to those of test series 1. The vinyl functionalization according to the invention was always superior to the commercially available UV primers due to the lower layer thickness and better adhesion.

### Test Series 4

A test series was performed as described for test series 1, except that DPGDA was used as the functionalizing reagent instead of HDDA. The results were similar to those of test series 1. The vinyl functionalization according to the invention was always superior to the commercially available UV primers due to the lower layer thickness and better adhesion.

### Test Series 5

A test series was performed as described for test series 1, except that TMPTA was used as the functionalizing reagent instead of HDDA. The results were similar to those of test series 1. The vinyl functionalization according to the invention was always superior to the commercially available UV primers due to the lower layer thickness and better adhesion.

### Test Series 6

### Example 1:

In an analogous manner as described for test series 1, a furniture surface decor H3399 having the structure ST28 (raw template) was functionalized with HDDA (1 g/m²).

For the comparative example, a commercially available UV primer (Plantag Primer 74170.5) was used instead at an application amount of 4 g/m². According to the technical data sheet, it contains: Propylidynetrimethanol, ethoxylated, ester with acrylic acid; 2-ethylhexyl acrylate and 2-hydroxy-3-phenoxypropyl acrylate. In both cases, a UV paint by the company Plantag 78700.1 (8 g/m²) was applied as topcoat. According to the technical data sheet, it contains: 1,6-hexanediol diacrylate, acrylic resin and methylbenzoyl formate. In contrast to test series 1, however, no excimer curing was performed. The following results were obtained:

| | Rt value | Gloss level | Hamberger Hobel | Martin Dale (DIN EN 16094) |
|---|---|---|---|---|
| Raw template | 78.8 µm | 4.1 (60°) | 40 N | B2 / A3 |
| HDDA + Plantag Topcoat 78700.1 | 78 µm | 7.3 (60°) | 40 N | B1 / A1 |
| Plantag Primer 74170.5 + Plantag Topcoat 78700.1 | 73 µm | 8.5 (60°) | 10 N | B1 / A1 |

### Example 2:

In an analogous manner as described for test series 1, a flooring panel having wood decor H1007 “Parquet Oak” and a flatter structure as surface was functionalized with DPGDA (application amount 1.5 g/m²). For the comparative example, a commercially available UV primer (UVILUX Primer 621-183) was used instead at an application amount of 4 g/m². According to the technical data sheet, it contains: exo-1,7,7-trimethylbicyclo[2.2.1]hept-2-yl acrylate, dipropylene glycol diacrylate, 2-propenoic acid, 2-methyl, 2-hydroxyethyl ester and ethyl phenyl (2,4,6-trimethylbenzoyl)phosphinate. In both cases, a UV topcoat of the company Bona (article no. 7720, acrylate paint, application amount 8 g/m²) was applied and cured with excimer as described in test series 1. The following results were obtained:

| | Rt value | Gloss level | Hamberger Hobel | Martin Dale (DIN EN 16094) |
|---|---|---|---|---|
| Raw template | 49 µm | 8.4 (60°) | 40 N | B2 / A3 |
| DPGDA + Bona UT 7720 | 47.2 µm | 3.1 (60°) | 40 N | B1 / A1 |
| UVILUX Primer 621-183 + Bona UT 7720 | 36 µm | 3.3 (60°) | 12 N | B1 / A1 |

### Example 3:

In an analogous manner as described for test series 1, a panel with synchronous structure ST 69 on the wood decor H2820 as surface was functionalized with 0.5 g/m² TMPTA. For the comparative example, a commercially available UV primer (Bergolin 1U080) was used instead at an application amount of 4 g/m². According to the technical data sheet, it contains: 4-(1,1-dimethyl)cyclohexyl acrylate, (5-ethyl-1,3-dioxan-5-yl)methyl acrylate, ethyl phenyl(2,4,6-trimethylbenzoyl)phosphinate and 1,1,1-trihydroxymethylpropyl triacrylate. Bergolin UV Topcoat 2U080-090, colorless (unsaturated acrylate resin, 11 g/m²) was used as topcoat in both cases and cured with excimer as described in test series 1. According to the technical data sheet, the topcoat contains: 1,6-hexanediol diacrylate (5-ethyl-1,3-dioxan-5-yl)methyl acrylate, bis(1,2,2,6,6-pentamethyl-4-piperidyl)sebacat ethyl phenyl(2,4,6-trimethylbenzoyl)phosphinate, methyl 1,2,2,6,6-pentamethyl-4-piperidyl sebacate and 1,1,1-trihydroxymethylpropyl triacrylate. The following results were obtained:

| | Rt value | Gloss level | Hamberger Hobel | Martin Dale (DIN EN 16094) |
|---|---|---|---|---|
| Raw template | 65 µm | 10.4 (60°) | 35 N | B2 / A3 |
| TMPTA + Bergolin 2U080 | 63.8 µm | 1.8 (60°) | 35 N | B1 / A1 |
| Bergolin 1U080 + Bergolin 2U080 | 54.2 µm | 5.2 (60°) | 10 N | B2 / A2 |

As a comparison of the Rt values to examples 1 to 3 shows, the structure is always best preserved with the painting according to the invention. Surfaces painted according to the invention have similarly good Hamberger Hobel results as the melamine resin starting surfaces (raw template), but achieve similarly good values in the Martin Dale test as melamine resin surfaces overpainted with UV paint.

1. A paintable material having a surface made of a plastic containing amino groups, wherein the surface is structured and that at least a part of the amino groups on the structured surface of the plastic containing amino groups has been functionalized covalently with vinyl groups by grafting a functionalizing reagent.

2. The paintable material according to claim 1, wherein the functionalizing reagent has at least one vinyl group and at least one group reactive towards the amino groups of the plastic containing amino groups.

3. The paintable material according to claim 1, wherein the functionalizing reagent has a molecular weight of 90 to 2000, preferably of 95 to 1100, and more preferably of 95 to 600.

4. The paintable material according to claim 3, wherein the further group in the functionalizing reagent, which is reactive towards the amino groups of the plastic containing amino groups, is selected from the group consisting of epoxides, anhydrides, acid chlorides, acid azides, sulfonyl chlorides, ketones, aldehydes, carboxylic acids, esters, in particular N-hydroxysuccinimide esters, imido esters, or carbonates, carbodiimides, isocyanates, isothiocyanates, alkyl halides, aryl halides, alkynes and vinyl groups such as, for example, acrylate, methacrylate, or acrylamide.

5. The paintable material according to claim 4, wherein the further group in the functionalizing reagent, which is reactive towards the amino groups of the plastic containing amino groups, is also a vinyl group.

6. The paintable material according to claim 5, wherein the grafting comprises applying the functionalizing reagent in an amount of less than 5 g/m², in particular less than 2 g/m² or less than 1 g/m² to the structured surface of the plastic containing amino groups, and subsequently heating or irradiating with UV or electron beams.

7. The paintable material according to claim 4, wherein the functionalizing reagent is selected from the group consisting of di-, tri-, tetra-, penta- or even higher functional acrylates, methacrylates, vinyl ethers and allyl ethers, wherein the functionalizing reagent may in particular be selected from the group consisting of trimethylolpropane triacrylate, dipropylene glycol diacrylate, tripropylene glycol diacrylate, hexanediol diacrylate, pentaerythritol tetraacrylate, dipentaerythritol pentaacrylate, dipentaerythritol hexaacrylate neopentyl glycol diacrylate, and propoxylated or ethoxylated variants of these compounds, polyalkylene glycol diacrylates, in particular polyethylene glycol diacrylates, divinyl ethers, in particular diethylene glycol divinyl ethers, triethylene glycol divinyl ethers or cyclohexanedimethanol divinyl ethers, and diallyl ethers.

8. The paintable material according to claim 7, wherein the vinyl groups in the material surface and/or in the functionalizing reagent are selected from the group consisting of acrylates, methacrylates, vinyl ethers, allyl ethers and vinyl aromatic compounds, the latter being selected in particular from styrene, C₁₋₄-alkyl-substituted styrene, stilbene, vinylbenzyldimethylamine, (4-vinylbenzyl)dimethylaminoethyl ether, N,N-dimethylaminoethylstyrene, tert-butoxystyrene and vinylpyridine.

9. The paintable material according to claim 8, wherein the plastic containing amino groups is selected from the group consisting of aminoplast resins, aminopolysiloxanes, polyvinylamines, polyalkyleneimines, aminoepoxide resins, and polyurethanes having terminal amino groups.

10. The paintable material according to claim 9, wherein the plastic containing amino groups is an aminoplast resin, in particular a melamine-formaldehyde resin or a melamine-urea-formaldehyde resin.

11. The paintable material according to claim 10, wherein the material is a sheet-shaped or board-shaped material, in particular a wooden material board; a carrier coated with a plastic containing amino groups; an impregnated or coated paper or a laminate containing one or more impregnated or coated papers, in particular a DPL, HPL or CPL, a compact board or another layered material.

12. A painted material having a structured paint surface which can be obtained by: (a) providing a paintable material according to claim 11, (b) applying a layer of a radiation-curing paint to the vinyl group-modified, structured plastic surface of the material, (c) radiation-curing the paint layer.

13. The painted material according to claim 12, wherein the radiation-curing paint is a topcoat and the painted material does not contain a paint primer or undercoat layer.

14. The painted material according to claim 12, wherein the total amount of radiation-curing paint applied to the plastic surface is less than 20 g/m², in particular less than 15 g/m² or less than 10 g/m².

15. The painted material according to claim 12, wherein the paint layer is an excimer-cured paint layer and/or has a gloss value of less than 10, preferably less than 5, in each case measured according to EN ISO 2813 with the 60° geometry.

16. The paintable material according to claim 11 or respectively a painted material, wherein the structured material surface or respectively the structured paint surface has an Rz value measured according to DIN EN ISO 4287 of at least 10 µm, in particular at least 15 µm or at least 20 µm.

17. The paintable material or respectively the painted material according to claim 16, wherein the surface structure of the structured material surface or respectively the structured paint surface is a decorative structure originally produced by embossing, lamination, calendering, etching, lasering or printing, which in particular represents the surface structure of wood, natural stone, artificial stone, ceramics, metal, mosaics, floorboards, tiles, joints or another decorative structure visible to the naked eye.

18. A method of producing a paintable material according to claim 11 comprising the following steps:
c) providing a material having a structured surface made of a plastic containing amino groups,
d) covalent functionalization of the structured surface with vinyl groups by
(i) contacting the structured surface with a functionalizing reagent having at least one vinyl group and at least one further group reactive towards the amino groups of the plastic containing amino groups, and
(ii) performing a chemical reaction to generate a covalent bond between the second reactive group of the functionalizing reagent and an amino group on the structured surface of the plastic containing amino groups, thereby obtaining a structured surface covalently modified with vinyl groups.

19. The method of producing a painted material having a structured paint surface according to claim 17, comprising the following steps:
a) performing a process, or providing a paintable material,
b) applying a layer of radiation-curing paint to the structured surface of the material functionalized with vinyl groups,
c) radiation curing of the paint layer.

20. The use of a vinyl functionalization as a substitute for a primer layer or undercoat in the painting of structured surfaces of plastics containing amino groups with radiation-curing paints.
